(19) United States
(12) Patent Application Publication
(10) Pub. No.: US 2018/0290174 A1
(43) Pub. Date: Oct. 11, 2018

(54) PORTABLE ULTRASONIC TRANSDUCER STRUCTURE

(71) Applicant: JeKen Ultrasonic Cleaner Limited, Dongguan (CN)

(72) Inventor: Hua Zhong, Dongguan (CN)

(21) Appl. No.: 15/944,806

(22) Filed: Apr. 4, 2018

(30) Foreign Application Priority Data
Apr. 6, 2017 (CN) 201720356544.0

(51) Int. Cl. B06B 1/06; B08B 3/12

(52) U.S. Cl. CPC B06B 1/0607; B08B 3/12

(57) ABSTRACT

The present invention discloses a portable ultrasonic transducer structure for cleaning. The transducer structure includes a front end cap for ultrasonic wave emission, a rear front end cap connected to the front end cap, at least one piezoelectric ceramic received in the rear front end cap and a waterproof cap surrounding the rear front end cap. The front end cap for ultrasonic wave emission has a double “U” symmetrical structure in a cross section view along an axial direction.

### TECHNICAL FIELD

The present disclosure relates to the technical field of transducers, in particular to a portable ultrasonic transducer structure for cleaning.

### BACKGROUND

Ultrasonic transducer is capable of converting electric energy into mechanical energy, and further generating ultrasonic waves to be transmitted. In the conversion process, the ultrasonic transducer itself consumes a small part of the power. As such, if the frequency of the ultrasonic wave is high, the demand for heat dissipation in the ultrasonic transducer will be high, too. Therefore, according to the characteristics of the ultrasonic transducer, design of the ultrasonic transducer must not only be considered with the energy conversion efficiency, but also needs to be considered with the heat dissipation effect. At the same time, the manufacture cost, service life, and the safety in use would be considered, too. Besides, because the resonant size of the transducer is determined by its resonant frequency, the higher the frequency, the smaller the size will be. However, this leads more difficulty for designing and manufacturing the parts thereof, and the requirement for heat dissipation will be higher.

In fact, traditional transducers have low efficiency while working in the water, the dissipated ultrasonic energy therefrom is not well-distributed, and the service life is short.

### SUMMARY

To achieve the above objective, the present disclosure provides the following technical solution: providing a portable ultrasonic transducer structure for cleaning, which includes a front end cap for ultrasonic wave emission, a rear front end cap connected to the front end cap. At least one piezoelectric ceramic is received in the rear front end cap and a waterproof cap surrounds the rear front end cap. And, the front end cap for ultrasonic wave emission has a double “U” symmetrical structure in a cross section view along an axial direction.

Preferably, the double “U” symmetrical structure is formed by shaping two symmetrical grooves on opposite surface of the front end cap.

Preferably, the U shape is replaced with V shape.

Preferably, the front end cap comprises a front end portion, a rear end portion, and a connection section in connection therebetween.

Preferably, a flange with a curved surface is extended from one end of the front end portion opposite to another flange extended from one end of the rear end portion, and each flange of the front end portion and the rear end portion is respectively sleeved on or extended from both ends of the connection section.

Preferably, the cross section of the front end portion, the connection section, and the rear end portion in a radial direction is circular.

Preferably, the piezoelectric ceramic is closed to one side of the front end cap, and a power conversion part of the transducer is received in the rear front end cap and being away from the front end cap.

Preferably, the outer surface of the transducer is further sandblasted and oxidized.

Preferably, the waterproof cap is provided with a wire outlet for receiving a power supply wire of the transducer.

Compared with the existing technology, the beneficial effects of the present disclosure are:

(1) The power conversion part of the transducer in the disclosure being surrounded by the waterproof cap, and the wire being connected to an ultrasonic power supply through the wire outlet of the waterproof cap. As such, the entire transducer can directly put into the water to work, after being waterproofed by using the waterproof cap;

(2) The front end cap of the transducer for ultrasonic wave emission making the front end portion, the connection section and the rear end portion thereof to emit ultrasonic energy, through a special double U-shaped design, so that the ultrasonic energy can be uniformly emitted into the liquid; and

(3) The hardness and corrosion resistance of the outer surface of the transducer being improved through sandblasting and oxidation treatment.

### BRIEF DESCRIPTION OF THE DRAWINGS

FIG. 1 is a schematic structural view of a portable ultrasonic transducer structure, according to an embodiment of the present disclosure.

Wherein, in the drawings: 1 represents the front end cap; 2 represents the rear front end cap; 3 represents the piezoelectric ceramics; 4 represents the waterproof cap; 5 represents the wire outlet; 6 represents the power conversion part; 101 represents the front end portion; 102 represents the connection section; 103 represents the rear end portion; 104 represents the flange.

### DETAILED DESCRIPTION

Next, a detailed explanation will be given for exemplary embodiments with reference to the drawings. In the following description of the drawings, a same or like reference sign is given to a same or like part. The drawings schematically represent configurations according to the exemplary embodiments of the present invention. Furthermore, the exemplary embodiments of the present invention described below are examples and may be modified as appropriate as long as the nature of the present invention is not altered.

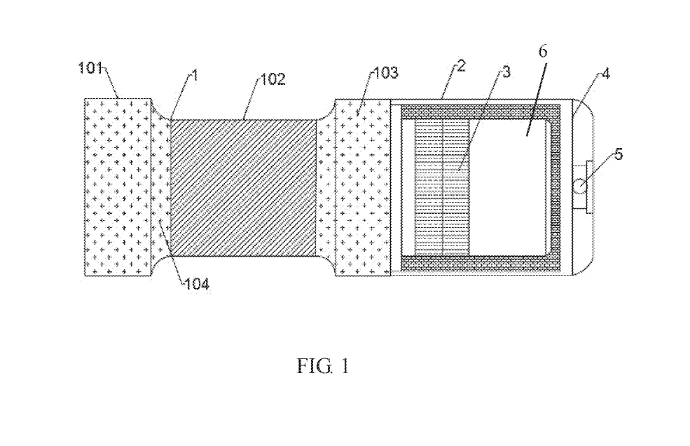

Referring to FIG. 1, the present disclosure discloses a portable ultrasonic transducer structure for cleaning, which includes a front end cap 1 for ultrasonic wave emission, a rear front end cap 2, at least one piezoelectric ceramic 3 and a waterproof cap 4. One end of the front end cap 1 for ultrasonic wave emission is connected to the rear front end cap 2, the piezoelectric ceramic 3 is received in the rear end cap 2. In this embodiment, the piezoelectric ceramic 3 is closed to one side of the front end cap 1, and a power conversion part 6 of the transducer is received in the rear front end cap 2 and being away from the front end cap 1. The waterproof cap 4 surrounds the end of the rear end cap 2 to protect the power conversion part of the transducer. The waterproof cap 4 is provided with a wire outlet 5 for receiving the power supply wire of the transducer.

The front end cap 1 for ultrasonic wave emission has a double “U” symmetrical structure, in a cross section view along an axial direction. In this embodiment, the double “U” symmetrical structure is formed by shaping two symmetrical grooves on opposite surface of the front end cap 1. In other embodiments, the U shape can be replaced with V shape, or the double “U” symmetrical structure is formed by other way, e.g. sanding the outer surface of the front end cap 1 to have smaller diameter at the middle portion. The front end cap 1 includes a front end portion 101, a connection section 102 and a rear end portion 103. The connection section 102 is in connection between the front end portion 101 and the rear end portion 103. A flange 104 with a curved surface is extended from one end of the front end portion 101 opposite to another flange 104 extended from one end of the rear end portion 103. The flange 104 of the front end portion 101 and the rear end portion 103 is respectively sleeved on or extended from both ends of the connection section 102. In this embodiment, the outer surface of the transducer is further sandblasted and oxidized. Furthermore, the cross section of the front end portion 101, the connection section 102, and the rear end portion 103 is circular, along a radial direction.

In the present disclosure, the power conversion part of the transducer is surrounded by the waterproof cap, and the wire is connected to an ultrasonic power supply through the outlet of the waterproof cap, while the wire is well waterproofed therein. As such, the entire transducer can be directly put into the water to work, after being waterproofed by using the waterproof cap. The front end cap 1 of the transducer has a special double “U” design, making all of the front end portion, connection section and the rear end portion emit ultrasonic energy, so that ultrasonic energy can be uniformly emitted into the liquid. The material on the outer surface of the transducer is sandblasted and in oxidation treatment, to improve the hardness and corrosion resistance thereof.

In this embodiment, the working frequency of the present transducer is around 50 KHz. Actually, only the transducer size within this frequency range can achieve a balance between power and portability. Otherwise, the transducer size will be large while the frequency is lower, or, if the frequency is high, the ultrasonic power will not be enough and cause a bad effect in cleaning.

For a person skilled in the art, it is apparent that the present disclosure is not limited to the details of the above exemplary embodiments, and the present disclosure can be implemented in other specific forms without departing from the spirit or essential features of the present disclosure. Therefore, the embodiments should be regarded as exemplary and non-restrictive from the point of view of the present disclosure, and the scope of the present disclosure is defined by the appended claims rather than the above description, and thus it is intended to fall under the scope of the present disclosure. All changes that come within the meaning and range of equivalency of the claimed are included in the disclosure. Any reference signs in the claims should not be regarded as limiting the involved claims.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A portable ultrasonic transducer structure for cleaning, comprising a front end cap for ultrasonic wave emission, a rear front end cap connected to the front end cap, at least one piezoelectric ceramic received in the rear front end cap and a waterproof cap surrounding the rear front end cap, and the front end cap for ultrasonic wave emission has a double “U” symmetrical structure in a cross section view along an axial direction.

2. The transducer structure according to claim 1, wherein the double “U” symmetrical structure is formed by shaping two symmetrical grooves on opposite surface of the front end cap.

3. The transducer structure according to claim 1, wherein the U structure is replaced with V shape.

4. The transducer structure according to claim 1, wherein the front end cap comprises a front end portion, a rear end portion, and a connection section in connection therebetween.

5. The transducer structure according to claim 4, wherein a flange with a curved surface is extended from one end of the front end portion opposite to another flange extended from one end of the rear end portion, and each flange of the front end portion and the rear end portion is respectively sleeved on or extended from both ends of the connection section.

6. The transducer structure according to claim 1, wherein the cross section of the front end portion, the connection section, and the rear end portion in a radial direction is circular.

7. The transducer structure according to claim 1, wherein the piezoelectric ceramic is closed to one side of the front end cap, and a power conversion part of the transducer is received in the rear front end cap and being away from the front end cap.

8. The transducer structure according to claim 1, wherein the outer surface of the transducer is further sandblasted and oxidized.

9. The transducer structure according to claim 1, wherein the waterproof cap is provided with a wire outlet for receiving a power supply wire of the transducer.

10. The transducer structure according to claim 1, wherein the working frequency of the present transducer is around 50 KHz.
